(19) United States
(12) Patent Application Publication
(10) Pub. No.: US 2009/0319895 A1
(43) Pub. Date: Dec. 24, 2009

(54) USE OF AVATARS

(76) Inventors: Michael Patrick Kinsella, Glasgow (GB); Lauren Bigelow, Acton, MA (US)

Correspondence Address: NIXON & VANDERHYE, PC, 901 NORTH GLEBE ROAD, 11TH FLOOR, ARLINGTON, VA, 22203, US

(21) Appl. No.: 12/279,637

(22) PCT Filed: Feb. 16, 2007
(86) PCT No.: PCT/GB2007/000553

§ 371 Date: Jun. 12, 2009

Related U.S. Application Data
(60) Provisional application No. 60/773,687, filed on Feb. 16, 2006.

(51) Int. Cl. G06F 3/048

(52) U.S. Cl. 715/706

(57) ABSTRACT

Information such as advertisements (26) or news is selected for a user based on the attributes (23) that the user has input to build (22) their avatar (21) or avatar environment. The advertisements may be selected for presentation (24) using one user's attributes or attribute history. Alternatively, the user's attributes may be used to proximity search for matching user attributes and those are used to select the advertisement. In another embodiment, the attributes are used to affect the behaviour of an agent representing the user.

The present invention relates to avatars, in particular advertising using avatars and affecting agent behaviour using avatars.

In the field of advertising, targeted advertising may be directed to recipients based on attributes of the recipients. These attributes can be gathered from a variety of sources, including from the recipients using questionnaires of preferences or other questions. The problem with gathering such attributes is that people are reluctant to give information about themselves, especially when presented with long and complicated questionnaires. This means that the advertisements are not always targeted at the right recipients.

It is an object of at least one aspect of the present invention to improve the targeting of information to users.

It is an object of at least one aspect of the present invention to affect the behaviour of an agent representing a user.

According to the first aspect of the present invention, there is provided a method of selecting information comprising the steps;
receiving at least one first attribute from a first user;
rendering a first avatar responsive to the at least one first attribute;
selecting information using the at least one first attribute.

Preferably, the information comprises an advertisement.

Alternatively, the information comprises news.

Preferably, the step of selecting information comprises combining the attributes to categorise the user.

Preferably, the at least one first attribute comprises an object.

Preferably, the least one first attribute further comprises content associated with the object.

Preferably, the method further comprises the step of presenting the selected information to the first user.

Alternatively, the method further comprises the steps, prior to the step of selecting the information, of:
receiving at least one second attribute from a second user;
rendering a second avatar responsive to the at least one second attribute; and
searching for the at-least one first attribute using the at least one second attribute,
   and the method further comprises the step of presenting the selected information to the second user.

Preferably, the step of searching comprises proximity searching.

Preferably, the step of selecting information further comprises weighting attributes and selecting the information dependant upon the weighting.

According to the second aspect of the present invention, there is provided a method of presenting an advertisement comprising the steps;
receiving at least one attribute from a user;
rendering an avatar responsive to the at least one attribute;
storing the at least one attribute so as to be associated with the user;
selecting an advertisement using the at least one attribute; and
presenting the advertisement to the user.

Preferably, the step of selecting an advertisement further comprises weighting attributes and selecting an advertisement dependant upon the weighting.

According to the third aspect of the present invention, there is provided a method comprising the steps;
receiving at least one attribute from each of a plurality of users;
rendering an avatar for each of the plurality of users responsive to the respective at least one attribute;
storing the at least one attribute so as to be associated with the respective user;
matching the at least one attribute associated with a first user of the plurality of users with the at least one attribute associated with a second user of the plurality of users;
selecting an advertisement using the at least one attribute associated with the second user; and
presenting the advertisement to the first user.

Preferably, the step of selecting an advertisement further comprises weighting attributes and selecting an advertisement dependant upon the weighting.

According to the fourth aspect of the present invention, there is provided a method of affecting the behaviour of an agent comprising the steps;
receiving at least one first attribute from a first user;
rendering a first avatar responsive to the at least one first attribute;
affecting the behaviour of an agent representing a user using the at least one first attribute.

Preferably, the at least one first attribute comprises an object.

Preferably, the least one first attribute further comprises content associated with the object.

Preferably, the represented user is the first user.

Alternatively, the method further comprises the steps, prior to the step of selecting the information, of:
receiving at least one second attribute from a second user;
rendering a second avatar responsive to the at least one second attribute; and
searching for the at least one first attribute using the at least one second attribute,
   wherein the represented user is the second user.

Preferably, the step of searching comprises proximity searching.

According to the fifth aspect of the present invention, there is provided a method of affecting the behaviour of an agent comprising the steps;
receiving at least one attribute from a user;
rendering an avatar responsive to the at least one attribute;
storing the at least one attribute so as to be associated with the user; and
affecting the behaviour of an agent representing the user using the at least one attribute.

Preferably, the attributes comprise historical attribute information.

According to the sixth aspect of the present invention, there is provided a method of affecting the behaviour of an agent comprising the steps;
receiving at least one attribute from each of a plurality of users;
rendering an avatar for each of the plurality of users responsive to the respective at least one attribute;
storing the at least one attribute so as to be associated with the respective user;
matching the at least one attribute associated with a first user of the plurality of users with the at least one attribute associated with a second user of the plurality of users;
affecting the behaviour of an agent representing the first user using the at least one attribute associated with the second user.

Preferably, the attributes comprise historical attribute information.

According to the seventh aspect of the present invention there is provided at least one computer program comprising program instructions for causing at least one computer to perform the method according to the first aspect.

According to the eighth aspect of the present invention there is provided at least one computer program comprising program instructions for causing at least one computer to perform the method according to the second aspect.

According to the ninth aspect of the present invention there is provided at least one computer program comprising program instructions for causing at least one computer to perform the method according to the third aspect.

According to the tenth aspect of the present invention there is provided at least one computer program comprising program instructions for causing at least one computer to perform the method according to the fourth aspect.

According to the tenth aspect of the present invention there is provided at least one computer program comprising program instructions for causing at least one computer to perform the method according to the fifth aspect.

According to the tenth aspect of the present invention there is provided at least one computer program comprising program instructions for causing at least one computer to perform the method according to the sixth aspect.

Preferably the at least one computer program is embodied on a recording medium or read-only memory, stored in at least one computer memory, or carried on an electrical carrier signal.

The present invention will be described by way of example only with reference to the figures in which;

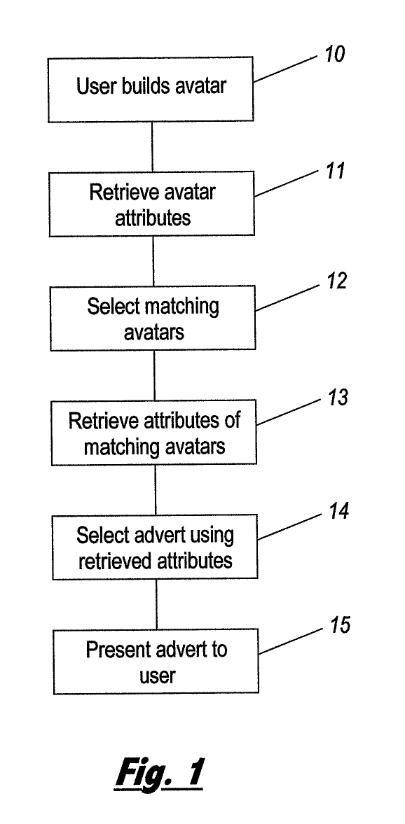

FIG. 1 illustrates a method according to a preferred embodiment of the present invention; and

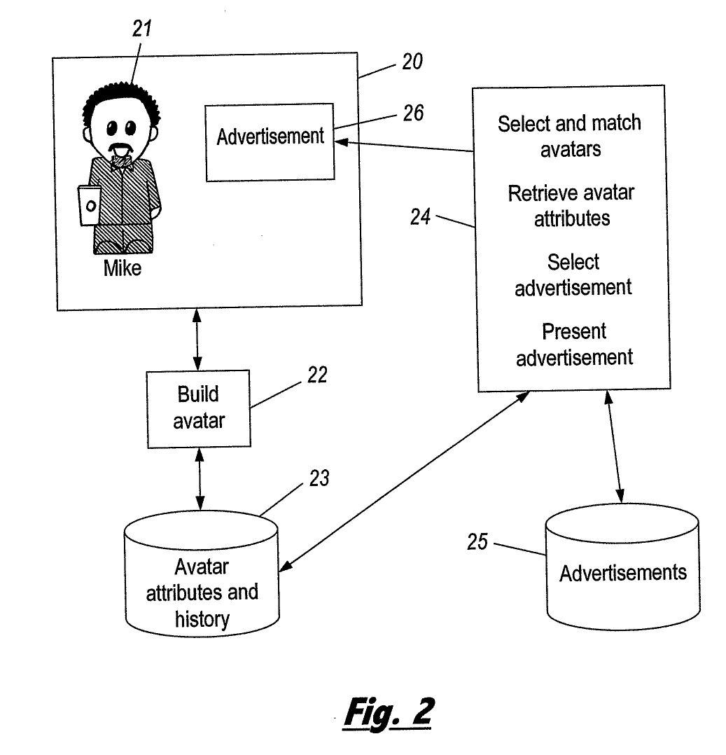

FIG. 2 illustrates in schematic form a system for implementing the present invention.

With reference to FIG. 1, a user builds an avatar 10. the avatar may be built using the methods described in International Patent Application No WO 2004/023336. In a first embodiment of direct targeting, the advertising is based purely on an individual avatar's attributes. These attributes can include gender, basic appearance, e.g., skin colour, hair style, clothing, interests (e.g., music, sport, pets, etc.), drinks (e.g., beer, wine, champagne, coffee) and favoured environments. The avatar is built by the user inputting attributes and seeing their avatar being modified interactively to their specification and being rendered on their computer or phone screen. The avatar attributes are subsequently retrieved 11 from the database in which they are stored and an advertisement is selected 14 using the retrieved attributes. The retrieved attributes can be taken individually or can be combined to categorise the user and thus to find out eligibility for specific advertisements. For example, an avatar having a dog could be eligible for dog food advertisements. Similarly, avatars that have been constructed to wear sparkly sandals, drink white wine and have a disco background, might be targeted by advertising for a new alco-pop drink. Finally, the advertisement is presented to the user 15. The advertisement can be presented in a variety of different ways, for example either as a pop-up on a browser display or a banner, or alternatively as an email message addressed to the recipient using their address supplied during the registration for their avatar account. The advertisement may be provided via a link from the rendered image corresponding to the attribute.

A second embodiment of indirect targeting can also be described with reference to FIG. 1. In this more complex case, an avatar's attributes are used to search the avatar database for “compatible” avatars 12. The search may be performed using proximity searching, for example in attribute space. This compatibility search may use an algorithm involving the weighted importance of several attributes. The weighting means that, for example, a person's clothing preference will be more important than the eye colour in the matching process. When attributes of matching avatars are retrieved 13, some of the attributes and preferences (which may be different from the original avatar) are selected and used to determine the appropriate advertising. For example, the majority of compatible avatars for an avatar wearing a hooded top and baggy jeans might show a preference for rock music, thus the individual associated with the original avatar, although not specifically showing the preference could be eligible for rock music advertisements.

In addition to targeting either directly or indirectly based on a snapshot of current attributes, it is possible to include historical data (e.g., what environments have been used over the past year, what previous interest has not been selected for some time, etc.) in the selecting of the appropriate advertising.

With reference to FIG. 2, a system is illustrated in accordance with an embodiment of the present invention. A user's computer screen 20 shows an avatar 21 that has been built using an application 22. The application stores the avatar attributes and a history of changes to the attributes in a database 23. The database contains attributes relating to the avatars of many users. An advertising server 24 uses a database of advertisements 25. The advertising server selects one avatar or alternatively a set of avatars that match one avatar using the attributes of that avatar. The advertising server retrieves avatar attributes of the one or many matching avatars and using the avatar attributes that have been retrieved selects an advertisement from the database and presents the selected advertisement 26 to the user on their screen.

This embodiment of the present invention provides improved targeting of the advertisement by the use of an avatar to collect attribute information from a user. Avatars have been found to be very popular with consumers who are keen to update them to reflect their own personal preferences in a way contrasting to their reluctance to complete questionnaires.

Within a virtual world populated by avatars it is possible create areas such as home pages or rooms. For example, a user can select objects to place in the rooms, like a labrador retriever, a music player, or a football. Each object may have associated with it detailed attributes such as pictures, text, video and keywords created by the user. When another user visits the room they can click on an object, and the bottom half of the screen changes to display the pictures, text, video and keywords associated with that object.

There are several ways that advertising can be integrated into this experience:

If the object is suggestive of a product (e.g. football relates to NFL®), an advertiser may buy placement for objects related to its products for example in a header banner, pop up window or the space devoted to describing the object through pictures, text and video.

In contextual advertisement serving, the assets related to the object can be analyzed for the content, for example specific keywords can be picked out of text (e.g. music for the music player) and an advertisement related to the keywords will be served (e.g. link to a music web site)

Alternatively, the keywords can be used directly to select advertising.

In a further embodiment, instead of advertising, any information, such as news, relevant to the user (based on the avatar attributes) can be selected and presented to the user.

In an alternative embodiment, instead of the attributes being used to select an advertisement, the attributes are used to affect the behaviour of an agent that represents the identity of the user. The agent may use the attributes to solicit advertising relevant to the user, perform transactions such as buying a product on behalf of the user, or to fetch further information relevant to the user. Other agent activities thus driven may include sending an avatar to the screen of another user's avatar, for example to give the other user's avatar a kiss.

Further modifications and improvements may be added without departing from the scope of the invention described by the claims.

1. A method of selecting information comprising the steps:
receiving at least one first attribute from a first user;
rendering a first avatar responsive to the at least one first attribute; and
selecting information using the at least one first attribute.

2. The method of claim 1, wherein the information comprises an advertisement.

3. The method of claim 1, wherein the information comprises news.

4. The method of claim 1, wherein the step of selecting information comprises combining the attributes to categorise the first user.

5. The method of claim 1, wherein the at least one first attribute comprises an object.

6. The method of claim 5, wherein the least one first attribute further comprises content associated with the object.

7. The method of claim 1, further comprising the step of presenting the selected information to the first user.

8. The method of claim 1, further comprising the steps, prior to the step of selecting the information, of: receiving at least one second attribute from a second user; rendering a second avatar responsive to the at least one second attribute; and searching for the at least one first attribute using the at least one second attribute, and the method further comprises the step of presenting the selected information to the second user.

9. The method of claim 8, wherein the step of searching comprises proximity searching.

10. The method of claim 1, wherein the step of selecting information further comprises weighting attributes and selecting the information dependant upon the weighting.

11. A method of presenting an advertisement comprising the steps:
receiving at least one attribute from a user;
rendering an avatar responsive to the at least one attribute;
storing the at least one attribute so as to be associated with the user;
selecting an advertisement using the at least one attribute; and
presenting the advertisement to the user.

12. The method of claim 11, wherein the step of selecting an advertisement further comprises weighting attributes and selecting an advertisement dependant upon the weighting.

13. A method of presenting an advertisement comprising the steps:
receiving at least one attribute from each of a plurality of users;
rendering an avatar for each of the plurality of users responsive to the respective at least one attribute;
storing the at least one attribute so as to be associated with the respective user;
matching the at least one attribute associated with a first user of the plurality of users with the at least one attribute associated with a second user of the plurality of users;
selecting an advertisement using the at least one attribute associated with the second user; and
presenting the advertisement to the first user.

14. The method of claim 13, wherein the step of selecting an advertisement further comprises weighting attributes and selecting an advertisement dependant upon the weighting.

15. A method of affecting the behavior of an agent comprising the steps;
receiving at least one first attribute from a first user;
rendering a first avatar responsive to the at least one first attribute; and
affecting the behavior of an agent representing a user using the at least one first attribute.

16. The method of claim 15, wherein the at least one first attribute comprises an object.

17. The method of claim 16, wherein the least one first attribute further comprises content associated with the object.

18. The method of claim 15, wherein the represented user is the first user.

19. The method of claim 15, further comprising the steps, prior to the step of selecting the information, of:
receiving at least one second attribute from a second user; rendering a second avatar responsive to the at least one second attribute; and
searching for the at least one first attribute using the at least one second attribute, wherein the represented user is the second user.

20. The method of claim 19, wherein the step of searching comprises proximity searching.

21. A method of affecting the behavior of an agent comprising the steps; receiving at least one attribute from a user;
rendering an avatar responsive to the at least one attribute;
storing the at least one attribute so as to be associated with the user; and
affecting the behavior of an agent representing the user using the at least one attribute.

22. The method of claim 21, wherein the attributes comprise historical attribute information.

23. A method of affecting the behavior of an agent comprising the steps:
receiving at least one attribute from each of a plurality of users;
rendering an avatar for each of the plurality of users responsive to the respective at least one attribute;
storing the at least one attribute so as to be associated with the respective user;
matching the at least one attribute associated with a first user of the plurality of users with the at least one attribute associated with a second user of the plurality of users; and
affecting the behavior of an agent representing the first user using the at least one attribute associated with the second user.

24. The method of claim 23, wherein the attributes comprise historical attribute information.

25. At least one computer program comprising program instructions for causing at least one computer to perform the method according to claim 1.

26. The at least one computer program of claim 25 embodied on a recording medium or read-only memory, stored in at least one computer memory, or carried on an electrical carrier signal.

27. At least one computer program comprising program instructions for causing at least one computer to perform the method according to claim 11.

28. The at least one computer program of claim 27 embodied on a recording medium or read-only memory, stored in at least one computer memory, or carried on an electrical carrier signal.

29. At least one computer program comprising program instructions for causing at least one computer to perform the method according to claim 13.

30. The at least one computer program of claim 29 embodied on a recording medium or read-only memory, stored in at least one computer memory, or carried on an electrical carrier signal.

31. At least one computer program comprising program instructions for causing at least one computer to perform the method according to claim 15.

32. The at least one computer program of claim 31 embodied on a recording medium or read-only memory, stored in at least one computer memory, or carried on an electrical carrier signal.

33. At least one computer program comprising program instructions for causing at least one computer to perform the method according to claim 21.

34. The at least one computer program of claim 33 embodied on a recording medium or read-only memory, stored in at least one computer memory, or carried on an electrical carrier signal.

35. At least one computer program comprising program instructions for causing at least one computer to perform the method according to claim 23.

36. The at least one computer program of claim 35 embodied on a recording medium or read-only memory, stored in at least one computer memory, or carried on an electrical carrier signal.
